(19) United States
(12) Patent Application Publication
(10) Pub. No.: US 2011/0238785 A1
(43) Pub. Date: Sep. 29, 2011

(54) MULTIMEDIA PROVIDING SERVICE

(76) Inventor: Kazunori Ozawa, Tokyo (JP)

(21) Appl. No.: 13/129,340

(22) PCT Filed: Nov. 2, 2009
(86) PCT No.: PCT/JP2009/068770

§ 371 Date: May 13, 2011

(30) Foreign Application Priority Data
Dec. 18, 2008 (JP) 2008-322644

(51) Int. Cl. G06F 15/16

(52) U.S. Cl. 709/217

(57) ABSTRACT

In an interval from the time an origination-side terminal (102-1) calls a termination-side terminal (102-2) until the time that the termination-side terminal (102-2) responds, a server (103) reads content data and reproduction environment information that indicates the reproduction environment of the content data from a content database (207), issues a request to the origination-side terminal (102-1) or the termination-side terminal (102-2) to add a session composed of something other than speech, and transmits content data and reproduction environment information that were read to the origination-side terminal (102-1) or the termination-side terminal (102-2), and, in the interval until the termination-side terminal (102-2) responds, the origination-side terminal (102-1) or the termination-side terminal (102-2) reproduces the content data that were transmitted based on the reproduction environment information.

### TECHNICAL FIELD

The present invention relates to a multimedia communication system that carries out multimedia communication, a multimedia providing service in the multimedia communication system, and a server.

### BACKGROUND ART

With the broadening of bandwidth in IP networks in recent years, terminals are coming into popular use that carry out multimedia communication that includes not only speech but also images. Multimedia communication not only uses the feature of “images,” which was absent in the speech communication of the prior art, to allow users to converse while seeing each other, but also serves various service needs.

However, when a calling party's terminal is calling a called party's terminal in a speech call session (before the called party's terminal responds), the display of an image such as a desired image or advertisement on the calling party's terminal or called party's terminal is not yet implemented.

A technology for transmitting a predetermined image to a terminal when a communication path is connected between the terminals has been considered (for example, refer to Patent Documents 1 and 2).

### LITERATURE OF THE PRIOR ART

JP-2004-072441-A

JP-2005-033442-A

### SUMMARY OF THE INVENTION

### Problem to be Solved by the Invention

Nevertheless, in the technology disclosed in Patent Documents 1 and 2, there is the concern that when an image that was transmitted is reproduced on a terminal, reproduction will not be possible in a format that is appropriate for the image (content) or for the reproducing terminal.

The present invention was realized in view of the above-described problem of the prior art and has as an object the provision of a multimedia service providing method, server, and multimedia communication system that can provide the service of reproducing desired content data on a terminal in a format that is appropriate to the content data and at a predetermined timing.

### Means for Solving the Problem

The multimedia service providing method of the present invention is a method of providing a multimedia service in a multimedia communication system that is made up of a plurality of terminals and a server that is connected to the plurality of terminals, that processes call processing signals of the plurality of terminals, and that has a database in which are stored content data that include images and reproduction environment information that indicates the reproduction environment of the content data; the multimedia service providing method including steps of:

the server reading the content data and the reproduction environment information from the database in the interval from placing a call by, from among the plurality of terminals, an origination-side terminal that performs speech call origination to, from among the plurality of terminals, a termination-side terminal that is the communication partner of the origination-side terminal, until the time that the termination-side terminal responds;

in the interval until the termination-side terminal responds, said server issuing a request to the origination-side terminal to additionally establish a session composed of something other than speech and transmitting the reproduction environment information and content data that were read to the origination-side terminal; and

in the interval until the termination-side terminal responds, the origination-side terminal reproducing content data that were transmitted from the server based on the reproduction environment information.

Alternatively, the multimedia service providing method is a method of providing a multimedia service in a multimedia communication system that is made up of a plurality of terminals and a server that is connected to the plurality of terminals, that processes call processing signals of the plurality of terminals, and that has a database in which are stored content data that include images and reproduction environment information that indicates the reproduction environment of the content data; the multimedia service providing method including steps of:

the server reading the content data and the reproduction environment information from the database in the interval from placing a call by, from among the plurality of terminals, an origination-side terminal that performs speech a call origination to, from among the plurality of terminals, a termination-side terminal that is the communication partner of the origination-side terminal, until the time that the termination-side terminal responds;

in the interval until the termination-side terminal responds, the server issuing a request to the termination-side terminal to additionally establish a session composed of something other than speech and transmitting the reproduction environment information and the content data that were read to the termination-side terminal; and

in the interval until the termination-side terminal responds, the termination-side terminal reproducing the content data that were transmitted from the server based on the reproduction environment information.

The server of the present invention is a server that is connected to a plurality of terminals and that processes call processing signals of the plurality of terminals, comprising:

a database in which are stored content data that include images and reproduction environment information that indicates the reproduction environment of the content data;

a call processing signal processor that, in the interval from placing a call by, from among the plurality of terminals, an origination-side terminal that performs speech call origination to, from among the plurality of terminals, a termination-side terminal that is the communication partner of the origination-side terminal, until the time that the termination-side terminal responds, reads the reproduction environment information from the database, transmits the reproduction environment information that was read to the origination-side terminal, and issues a request to the origination-side terminal to additionally establish a session composed of something other than speech; and

an origination-side terminal data transmission unit that, in the interval until the termination-side terminal responds, reads the content data from the database and transmits the content data that were read to the origination-side terminal.

Further, a server that is connected to a plurality of terminals and that processes call processing signals of the plurality of terminals comprises:

a database in which are stored content data that include images and reproduction environment information that indicates the reproduction environment of the content data;

a call processing signal processor that, in the interval from placing a call by, from among the plurality of terminals, an origination-side terminal that performs speech call origination to, from among the plurality of terminals, a termination-side terminal that is the communication partner of the origination-side terminal, until the time that the termination-side terminal responds, reads the reproduction environment information from the database, transmits the reproduction environment information that was read to the termination-side terminal, and issues a request to the termination-side terminal to additionally establish a session composed of something other than speech; and

a termination-side terminal data transmission unit that, in the interval until the termination-side terminal responds, reads the content data from the database and transmits the content data that were read to the termination-side terminal.

The multimedia communication system of the present invention is a multimedia communication system that is made up of a plurality of terminals and a server that is connected to the plurality of terminals and that processes call processing signals of the plurality of terminals, wherein:

the server has a database in which are stored content data that include images and reproduction environment information that indicates the reproduction environment of the content data, and further, in the interval from placing a call by, from among the plurality of terminals, an origination-side terminal that performs speech call origination to, from among the plurality of terminals, a termination-side terminal that is the communication partner of the origination-side terminal, until the time that the termination-side terminal responds, reads the content data and the reproduction environment information from the database, issues a request to the origination-side terminal to additionally establish a session composed of something other than speech, and transmits the content data and the reproduction environment information that were read to the origination-side terminal; and

the origination-side terminal, in the interval until the termination-side terminal responds, reproduces the content data that were transmitted from the server based on the reproduction environment information.

In addition, in a multimedia communication system that is made up of a plurality of terminals and a server that is connected to the plurality of terminals and that processes call processing signals of the plurality of terminals;

the server has a database in which are stored content data that include images and reproduction environment information that indicates the reproduction environment of the content data, and further, in the interval from placing a call by, from among the plurality of terminals, an origination-side terminal that performs speech call origination to, from among the plurality of terminals, a termination-side terminal that is the communication partner of the origination-side terminal, until the time that the termination-side terminal responds, reads the content data and the reproduction environment information from the database, issues a request to the termination-side terminal to additionally establish a session composed of something other than speech, and transmits to the termination-side terminal the content data and the reproduction environment information that were read; and
the termination-side terminal, in the interval until the termination-side terminal responds, reproduces the content data that were transmitted from the server based on the reproduction environment information.

### EFFECT OF THE INVENTION

In the present invention as described hereinabove, a system for communication by means of speech is configured to, during the interval until a termination-side terminal responds, add a session such as an image session and transmit content data such as image data that were stored in advance in a database, whereby a service can be offered to, during the interval until the termination-side terminal responds, add to a terminal a session other than speech, for example, an image session, and reproduce the content data that includes, for example, images in a format that is appropriate to the content data.

### BRIEF DESCRIPTION OF THE DRAWINGS

FIG. 1 shows one form of the multimedia communication system of the present invention;

FIG. 2 shows the first exemplary embodiment of the multimedia communication apparatus that is shown in FIG. 1;

FIG. 3 shows one construction of the content database shown in FIG. 2;

FIG. 4 is a flow chart for describing the first method of the multimedia communication method in the multimedia communication apparatus shown in FIG. 2;

FIG. 5 shows one form of the origination-side terminal shown in FIG. 1;

FIG. 6 shows the second exemplary embodiment of the multimedia communication apparatus shown in FIG. 1;

FIG. 7 is a flow chart for describing the first method of the multimedia communication method in the multimedia communication apparatus shown in FIG. 6;

FIG. 8 shows one form of the termination-side terminal shown in FIG. 1;

FIG. 9 shows the third exemplary embodiment of the multimedia communication apparatus shown in FIG. I;

FIG. 10 shows the fourth exemplary embodiment of the multimedia communication apparatus shown in FIG. 1;

FIG. 11 shows one construction of the advertisement content database shown in FIG. 10;

FIG. 12 shows the fifth exemplary embodiment of the multimedia communication apparatus shown in FIG. 1;

FIG. 13 shows one construction of the preferential treatment information database in which the number of transmissions of advertisement data is placed in correspondence with preferential treatment information; and

FIG. 14 shows one construction of the preferential treatment information database in which the transmission time of advertisement data is placed in correspondence with the preferential treatment information.

### BEST MODE FOR CARRYING OUT THE INVENTION

Exemplary embodiments of the present invention are next described with reference to the accompanying drawings.

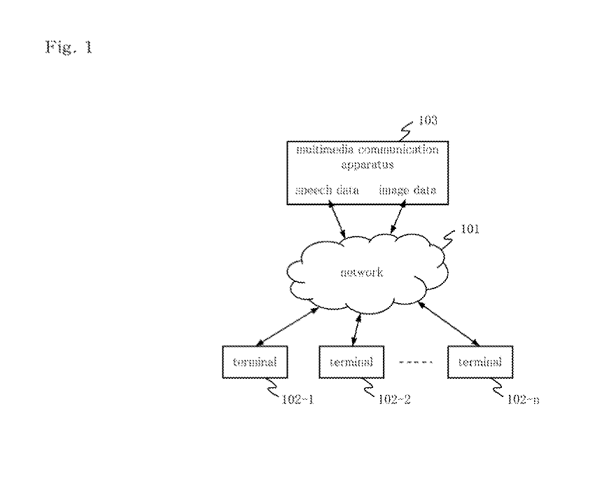

FIG. 1 shows one form of the multimedia communication system of the present invention.

As shown in FIG. 1, in this mode, a plurality of terminals 102-1-102-n and multimedia communication apparatus 103 are connected by way of network 101.

Terminals 102-1-102-n are communication terminals that are represented by multimedia terminals that can transmit and receive images and speech. Each of terminals 102-1-102-n is capable of call origination and call termination. Terminals 102-1-102-n encode as speech data the speech that is collected by speech collection means such as microphones that are provided in terminals 102-1-102-n and transmit the encoded speech data. Terminals 102-1-102-n further encode as image data images that are captured by image capture means such as cameras that are provided in terminals 102-1-102-n and transmit the encoded image data. In addition, speech is decoded from speech data that are received, and the speech that has been decoded is reproduced by a speech reproduction means such as speakers that are provided in terminals 102-1-102-n. Images are decoded from the image data that are received, and the images that have been decoded are reproduced by image reproduction means such as displays that are provided in terminals 102-1-102-n.

Multimedia communication apparatus 103 intermediates the transfer of speech data and image data that are transmitted and received among terminals 102-1-102-n by way of network 101. In addition, multimedia communication apparatus 103 further has the role of a server that transmits any content or character strings to terminals 102-1-102-n.

### First Exemplary Embodiment

The first exemplary embodiment of multimedia communication apparatus 103 shown in FIG. 1 is next described.

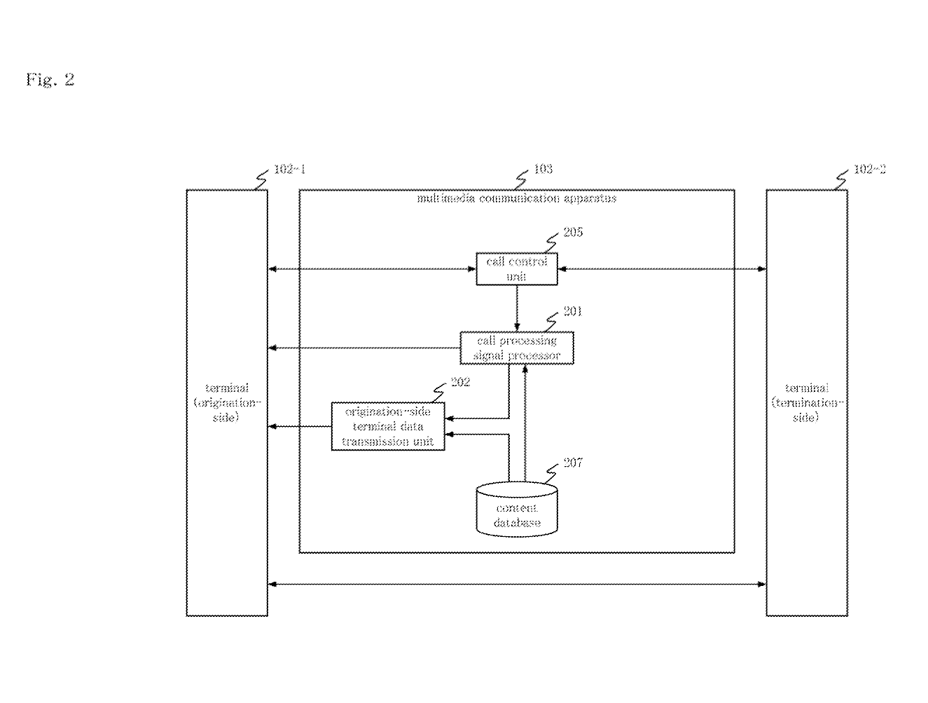

FIG. 2 shows the first exemplary embodiment of multimedia communication apparatus 103 shown in FIG. 1. Explanation here regards a case in which communication is implemented between terminal 102-1 and terminal 102-2. In this case, terminal 102-1 is the origination-side terminal and terminal 102-2 is the termination-side terminal that is the communication partner of terminal 102-1. The operations are identical to the operations described below regardless of which terminal of terminals 102-3-102-n is the origination-side terminal or the termination-side terminal.

The first exemplary embodiment of multimedia communication apparatus 103 shown in FIG. 1 is made up of call control unit 205, call processing signal processor 201, origination-side terminal data transmission unit 202, and content database 207, as shown in FIG. 2.

Call control unit 205 receives a call connection signal requesting the initiation of a speech call session from origination-side terminal 102-1 and relays and transmits this call connection signal to terminal 102-2. In addition, the reproduction environment information of the encoded speech data that are sent from terminal 102-1 is transmitted to terminal 102-2. At the same time as these operations, call control unit 205 supplies notification that a speech session has been started to call processing signal processor 201. In this case, for example, SIP (Session Initiation Protocol: RFC 3261) of the IETF standard can be used in the call connection signal for the speech call session. Here, the reproduction environment information of the encoded data is information necessary for reproducing the encoded data in terminals 102-1 and 102-2. For example, the reproduction environment information is the information for receiving the encoded data (address, port, format, application for reproduction, etc.) and the band value used in the encoded data. Here, the reproduction environment information can employ, for example, the protocol of SDP (Session Description Protocol: RFC 2327) of the IETF standards. The notification from call control unit 205 to call processing signal processor 201 can also employ, for example, the above-described SIP or can employ MEGACO signals of the IETF standards.

Call processing signal processor 201 receives the notification of the initiation of a speech call session from call control unit 205 by SIP or MEGACO (Media Gateway Control), reads reproduction environment information that relates to content such as image content that is to be subsequently transmitted from the content database, and uses a command such as reINVITE of SIP to transmit to origination-side terminal 102-1 an addition instruction of a session other than speech such as the addition instruction of an image session as well as the reproduction environment information. Here, the image content may be content composed of, for example, still pictures or moving pictures.

Call processing signal processor 201 further supplies a content transmission instruction to origination-side terminal data transmission unit 202.

Upon input of the content transmission instruction, origination-side terminal data transmission unit 202 reads from content database 207 data such as encoded image content data that are designated by the called party, encoded image content data that are designated by the calling party, or encoded image content data that have been determined in advance, and sends the encoded image content data stored in RIP packets to origination-side terminal 102-1.

Terminal 102-2 next receives a speech session initiation request signal, and in the event of a termination response to this signal, a termination response signal is transmitted from terminal 102-2 to call control unit 205.

Upon receiving the termination response signal transmitted from terminal 102-2, call control unit 205 supplies an end notification to call processing signal processor 201, and further, relays and sends the termination response signal to terminal 102-1.

Upon receiving the end notification that was supplied from call control unit 205, call processing signal processor 201 transmits a call control signal of the image session end to the origination-side terminal, and further, issues an instruction to origination-side terminal data transmission unit 202 to end RIP transmission of the image content. Upon receiving the instruction to end the RTP transmission, origination-side terminal data transmission unit 202 halts the transmission of RTP packet data that hold image content data to origination-side terminal 102-1.

A plurality of items of content data such as image data of moving pictures or still pictures and speech data are stored in advance in content database 207. In addition, character data (character information) may also be stored as content data. At least a portion of this content data may be registered and stored in content database 207 by an end user that can connect with multimedia communication apparatus 103. The method of registration may be a typical method such as writing desired information to a server (database) in which a variety of information is stored from a terminal that is operated by the end user.

When network 101 is, for example, a packet exchange network, origination-side terminal data transmission unit 202 can be configured as a RTP (Real-Time Transport Protocol) packet transmission unit.

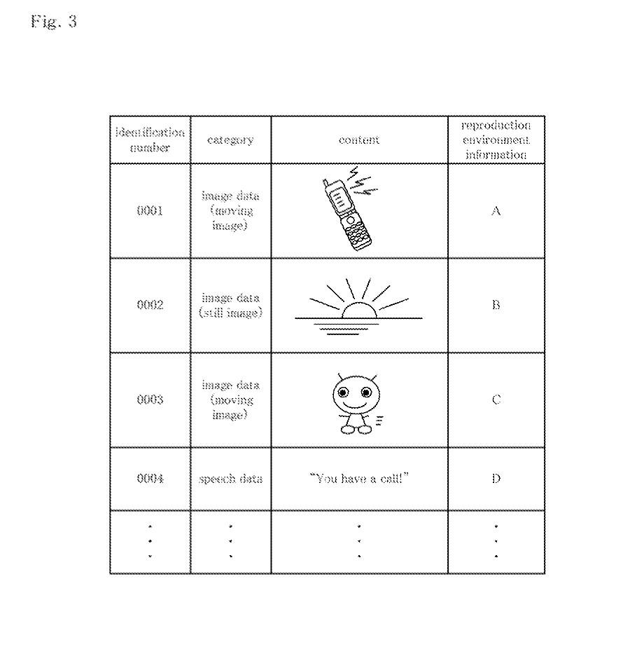

FIG. 3 shows one construction of content database 207 shown in FIG. 2.

As shown in FIG. 3, image data such as moving images or still images or speech data are stored in content database 207 shown in FIG. 2. An identification number that is uniquely conferred to each item of data, a category, and reproduction environment information are placed in correspondence and stored with each item of the image data or speech data. For example, identification number “0001,” the category “image data (moving picture),” and reproduction environment information “A” are placed in correspondence with content that is a moving picture of a portable telephone ringing. In addition, identification number “0002,” the category “image data (still picture),” and reproduction environment information “B” are placed in correspondence with content that is a still picture of the sun rising on a horizon. Still further, identification number “0003,” the category “image data (moving picture),” and reproduction environment information “C” are placed in correspondence with content that is a moving picture of a character moving. Finally, identification number “0004,” the category “speech data,” and reproduction environment information “D” are placed in correspondence with content that is the speech “You have a call!”

Content database 207 may further be connected to the outside of multimedia communication apparatus 103 and content may be read by multimedia communication apparatus 103 as necessary. An end user can register content database beforehand.

The multimedia communication method in multimedia communication apparatus 103 shown in FIG. 2 is next described.

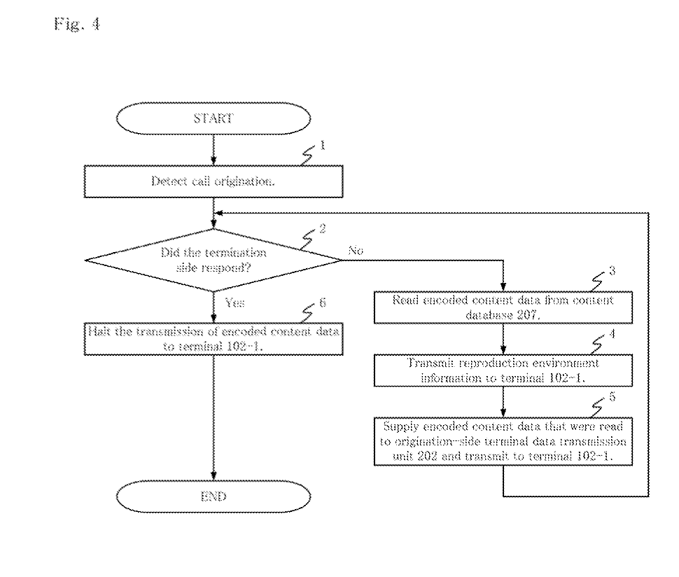

FIG. 4 is a flow chart for describing the first method of the multimedia communication method in multimedia communication apparatus 103 shown in FIG. 2.

First, when speech origination from terminal 102-1 shown in FIG. 2 to terminal 102-2 is detected in call control unit 205 in Step 1, it is next determined in Step 2 whether terminal 102-2 that is the termination-side terminal has responded or not.

When it is determined in call control unit 205 that terminal 102-2 has not responded, notification is supplied from call control unit 205 to call processing signal processor 201 that a speech session has been initiated. Upon receiving the notification supplied from call control unit 205, call processing signal processor 201 reads content that has been encoded from content database 207 to origination-side terminal data transmission unit 202 in Step 3.

At this time, the content that is read may be content that is selected in accordance with the termination-side terminal. In other words, when the correspondence between the identification number of content and information for identifying terminals 102-1-102-n has been stored in advance in content database 207, content may be selected in accordance with this correspondence and may be the content that is read. For example, a case is presented in which the information for identifying terminal 102-2 and the identification number “0002” are placed in correspondence. At this time, when the termination-side terminal is terminal 102-2, the content of identification number “0002” may be the content that is read. Alternatively, the content may also be content that is selected and read in accordance with the origination-side terminal. In this case, information for identifying the termination-side terminal or origination-side terminal is supplied from call processing signal processor 201 to origination-side terminal data transmission unit 202. The information for identifying terminals 102-1-102-n in this case may be the telephone numbers of terminals 102-1-102-n, but the information may be any information that can identify terminals 102-1-102-n.

Reproduction environment information that has been placed in correspondence with the content is read from content database 207 together with the content. Call processing signal processor 201 uses, for example, a reINVITE command to issue a request to origination-side terminal 102-1 to additionally establish a session other than a speech session such as, for example, an image session and transmits the reproduction environment information that was read to terminal 102-1 in Step 4.

Encoded data of the content that has been encoded are supplied to origination-side terminal data transmission unit 202 in Step 5.

Encoded data of the content are then transmitted to terminal 102-1 from origination-side terminal data transmission unit 202.

A configuration may be adopted in which the encoded image content data are stored in a file using a file format such as 3GPP format (extension: 3GP) that is an image format developed for portable telephone service by the standardization group 3GPP (3^{rd} Generation Partnership Project) or MP4 format, which is one file format for storing compressed moving picture data of MPEG-4 (Moving Picture Experts Group phase 4) format and then stored in content database 207, following which HTTP (HyperText Transfer Protocol) or TCP (Transmission Control Protocol) is used to transmit the file to terminal 102-1 by way of a network (not shown). By adopting this configuration, the encoded image content data can be accepted even by a terminal that does not handle a reINVITE command.

On the other hand, when it is determined in call control unit 205 that terminal 102-2 has responded, call control unit 205 issues notification to call processing signal processor 201 that a termination response has been received, and call processing signal processor 201 supplies an instruction to origination-side terminal data transmission unit 202 to halt transmission of encoded content data. Origination-side terminal data transmission unit 202 receives the halt instruction that was supplied from call processing signal processor 201 and halts the transmission of encoded content data to origination-side terminal 102-1 in Step 6.

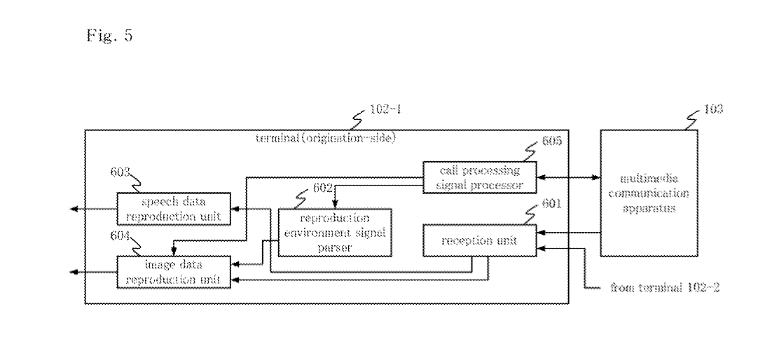

FIG. 5 shows one form of terminal 102-1 that was shown in FIG. 1. FIG. 5 shows, of the form of terminal 102-1 shown in FIG. 1, only the reception function portions that relate to the present invention.

As shown in FIG. 5, terminal 102-1 shown in FIG. 1 is provided with reception unit 601, reproduction environment signal parser 602, speech data reproduction unit 603, image data reproduction unit 604, and call processing signal processor 605.

Call processing signal processor 605, after using, for example, an INVITE command to send a speech origination session establishment request to multimedia communication apparatus 103, waits for the reception of a termination response signal regarding the speech session. When call processing signal processor 605 receives from multimedia communication apparatus 103 an reINVITE request requesting the establishment of a session other than speech such as an image session before receiving the termination response signal, call processing signal processor 605 both causes image data reproduction unit 604 to prepare for image data reproduction and causes reproduction environment signal parser 602 to supply and set to image data reproduction unit 604 setting values of various image encoding parameters that were obtained by parsing reproduction environment signals of the encoded content data that were received together with the reINVITE from multimedia communication apparatus 103.

Reception unit 601 receives encoded content data RTP packets from multimedia communication apparatus 103, extracts the encoded content data from the RTP packets, and supplies the encoded content data to image data reproduction unit 604.

In the interval until a halt signal comes from call processing signal processor 605, image data reproduction unit 604 decodes and reproduces the encoded content data that are received from reception unit 601 by means of the image encoding parameters that were set. When a halt signal arrives from call processing signal processor 605, image data reproduction unit 604 immediately halts the decoding and reproduction of the encoded content data.

Upon receiving the termination response signal of terminal 102-2 from multimedia communication apparatus 103, call processing signal processor 605 issues an instruction to image data reproduction unit 604 to halt decoding and reproduction of encoded content data. Call processing signal processor 605 further issues an instruction to speech data reproduction unit 603 to begin decoding and reproduction of encoded speech data.

Reception unit 601 receives RTP packets in which encoded speech data are stored from partner terminal 102-2 and extracts the encoded speech data to supply to speech data reproduction unit 603.

Upon receiving the instruction to begin decoding and reproduction of encoded speech data from call processing signal processor 605, speech data reproduction unit 603 receives the encoded speech data as input from reception unit 601, performs decoding and reproduction and supplies the speech signal. If reproduction environment information has been supplied from call processing signal processor 605 at this time, the speech data are reproduced based on the reproduction environment information.

The form of terminal 102-1 shown in FIG. 5 is identical to the form in the exemplary embodiments to be described hereinbelow.

As a result, while terminal 102-1 is calling terminal 102-2, content that was read from content database 207 is reproduced in terminal 102-1 using the reproduction environment information. In addition, when a speech conversation begins, speech data that were transmitted from terminal 102-2 are reproduced in terminal 102-1 using the reproduction environment information.

In the present exemplary embodiment as described hereinabove, when speech conversation is carried out from terminal 102-1 to terminal 102-2, predetermined content is reproduced in terminal 102-1 under conditions appropriate to terminal 102-1 and to the content while terminal 102-1 is calling terminal 102-2.

Although call control unit 205 was installed in multimedia communication apparatus 103 in FIG. 2 in the present exemplary embodiment as described hereinabove, call control unit 205 alone can also be implemented in a device other than multimedia communication apparatus 103. Adopting such a configuration is advantageous because it can flexibly ensure scalability. In this case, instructions can be reported using SIP or MEGACO between call processing signal processor 201 and the device in which call control unit 205 is provided.

### Second Exemplary Embodiment

The second exemplary embodiment of multimedia communication apparatus 103 shown in FIG. 1 is next described.

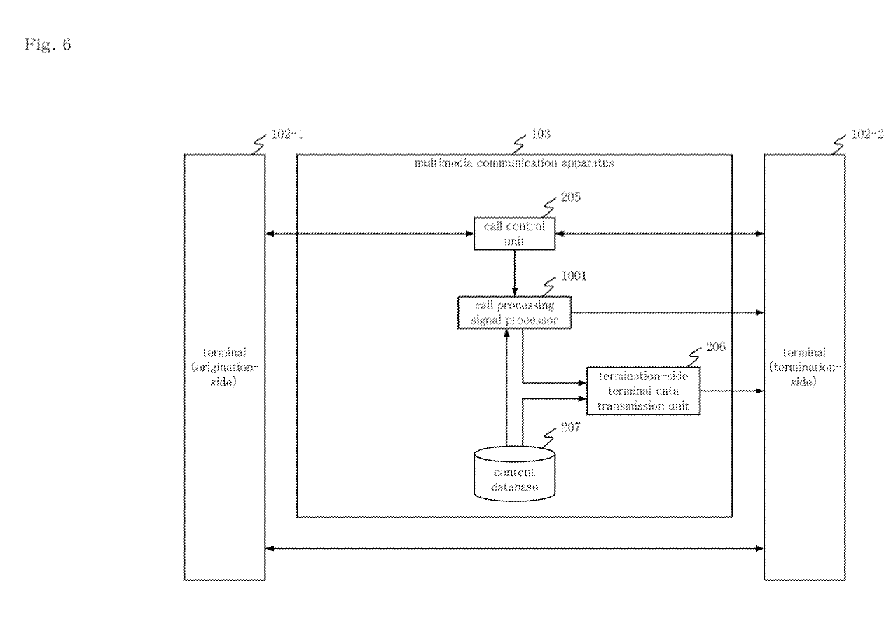

FIG. 6 shows the second exemplary embodiment of multimedia communication apparatus 103 shown in FIG. 1. Here, a case is described by way of example in which communication is carried out between terminal 102-1 and terminal 102-2. In addition, terminal 102-1 is the origination-side terminal, and terminal 102-2 is the termination-side terminal that is the communication partner of terminal 102-1. However, the operations are identical to the operations described hereinbelow regardless of which of terminals 102-3-102-n is the origination-side terminal or the termination-side terminal.

As shown in FIG. 6, the second exemplary embodiment of multimedia communication apparatus 103 shown in FIG. 1 is made up of call control unit 205, call processing signal processor 1001, termination-side terminal data transmission unit 206, and content database 207.

Call control unit 205 receives a call connection signal requesting the initiation of a speech call session from origination-side terminal 102-1 and relays and sends this call connection signal to terminal 102-2. In addition, the reproduction environment information of the encoded speech data sent from terminal 102-1 is sent to terminal 102-2.

At the same time as the above-described operations, call control unit 205 supplies notification to call processing signal processor 1001 that a speech session has started.

Here, SIP (Session Initiation Protocol RFC 3261) of the IETF standards can be used for the call connection signal for the speech call session. Here, the reproduction environment information of encoded data is information necessary for the reproduction of the encoded data in terminal's 102-1 and 102-2. For example, the reproduction environment information is information for receiving the encoded data (address, port, format, application for effecting reproduction, etc.) and the band value used by the encoded data. The reproduction environment information can use a protocol such as SDP (Session Description Protocol: RFC 2327) of the IETF standards.

The notification to call processing signal processor 1001 from call control unit 205 can also use, for example, the above-described SIP, or alternatively, can use MEGACO signals of the IETF standards.

Call processing signal processor 1001 receives the notification of the initiation of the speech call session from call control unit 205 by, for example, SIP or MEGACO, reads reproduction environment information relating to content such as image content that is to be sent from content database 207, and, using a command such as reINVITE of SIP, sends to termination-side terminal 102-2 an addition instruction of a session other than speech such as an addition instruction of an image session as well as reproduction environment information. Here, the image content may be content composed of, for example, still pictures or moving pictures.

Call processing signal processor 1001 further supplies an instruction to send content to termination-side terminal data transmission unit 206. Termination-side terminal data transmission unit 206 receives the content transmission instruction, reads from content database 207 encoded image content data that are designated by the calling party, encoded image content data that are designated by the called party, or encoded image content data that have been determined in advance, stores the encoded image content data in RTP packets, and sends the RTP packets to termination-side terminal 102-2.

Terminal 102-2 next receives the speech session initiation request signal, and, in the case of a termination response to this signal, a termination response signal is transmitted from terminal 102-2 to call control unit 205.

Upon receiving the termination response signal that was transmitted from terminal 102-2, call control unit 205 supplies an end notification to call processing signal processor 1001, and further relays and sends the termination response signal to terminal 102-1.

Upon receiving the end notification that was supplied from call control unit 205, call processing signal processor 1001 sends a call control signal of the image session end to termination-side terminal 102-2 and further issues an instruction to termination-side terminal data transmission unit 206 to end the RTP transmission of image content.

Upon receiving the instruction to end RTP transmission that was instructed from call processing signal processor 1001, termination-side terminal data transmission unit 206 halts the transmission of the RTP packet data that stores image content data to termination-side terminal 102-2.

Content database 207 is identical to content database 207 in the first exemplary embodiment. Of the construction of content database 207 in the first exemplary embodiment (the construction shown in FIG. 4), the construction need not store reproduction environment information.

The multimedia communication method in multimedia communication apparatus 103 shown in FIG. 6 is next described.

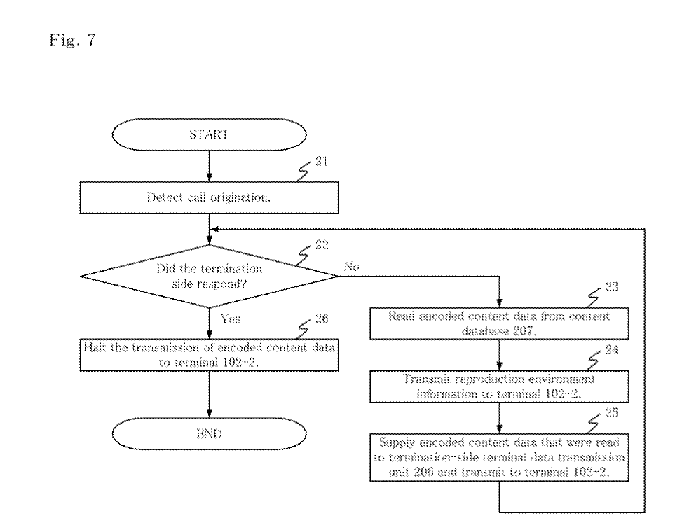

FIG. 7 is a flow chart for describing the first method of the multimedia communication method in multimedia communication apparatus 103 shown in FIG. 6.

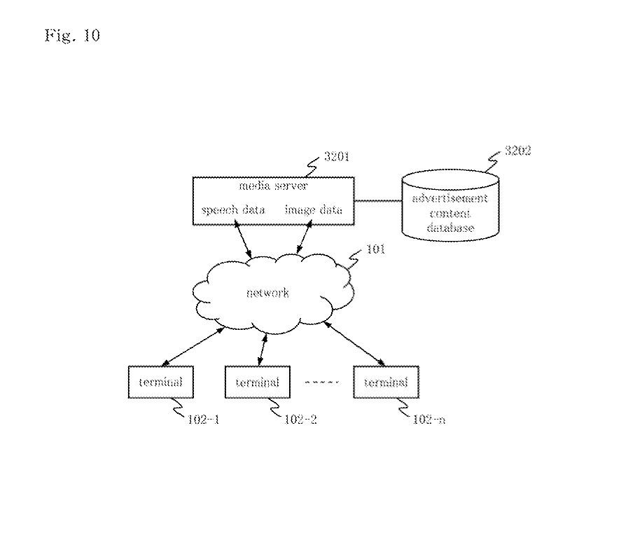

First, when speech origination from terminal 102-1 to terminal 102-2 shown in FIG. 10 is detected in call processing signal processor 1001 in Step 21, it is first determined in Step 22 whether terminal 102-2 that is the termination-side terminal has responded or not.

If it is determined in call control unit 205 that terminal 102-2 did not respond, notification that a speech session was initiated is supplied from call control unit 205 to call processing signal processor 1001.

When the notification that was supplied from call control unit 205 is received, call processing signal processor 1001 reads content that has been encoded from content database 207 to termination-side terminal data transmission unit 206 in Step 23.

In addition, reproduction environment information that was placed in correspondence with the content is further read from content database 207 together with the content. Call processing signal processor 1001 uses, for example, a reINVITE command to issue a request to termination-side terminal 102-2 to additionally establish a session other than a speech session such as an image session and transmits the reproduction environment information that was read to terminal 102-2 in Step 24.

In addition, encoded data of the content that was encoded are supplied to termination-side terminal data transmission unit 206 in Step 25.

The content that is read at this time may be content selected in accordance with the termination-side terminal as in the first exemplary embodiment. Alternatively, the content may be selected and read in accordance with the origination-side terminal.

The encoded data of the content are then transmitted from termination-side terminal data transmission unit 206 to terminal 102-2.

A configuration may be adopted in which the encoded image content data are stored in a file using a file format such as 3GPP format (extension: 3GP) that is an image format developed for portable telephone service by the standardization group 3GPP (3^{rd} Generation Partnership Project) or MP4 format, which is one file format for storing compressed moving picture data of MPEG-4 (Moving Picture Experts Group phase 4) format and then stored in content database 207, following which HTTP (HyperText Transfer Protocol) or TCP (Transmission Control Protocol) is used to transmit the file to terminal 102-2 by way of a network (not shown). By adopting this configuration, the encoded image content data can be accepted even by a terminal that does not handle reINVITE commands.

On the other hand, when it is determined in call control unit 205 that terminal 102-2 has responded, call control unit 205 supplies notification to call processing signal processor 1001 that a termination response was received, and call processing signal processor 1001 supplies an instruction to termination-side terminal data transmission unit 206 to halt transmission of encoded content data. Termination-side terminal data transmission unit 206 receives the halt instruction that was supplied from call processing signal processor 1001 and halts the transmission of the encoded content data to termination-side terminal 102-2 in Step 26.

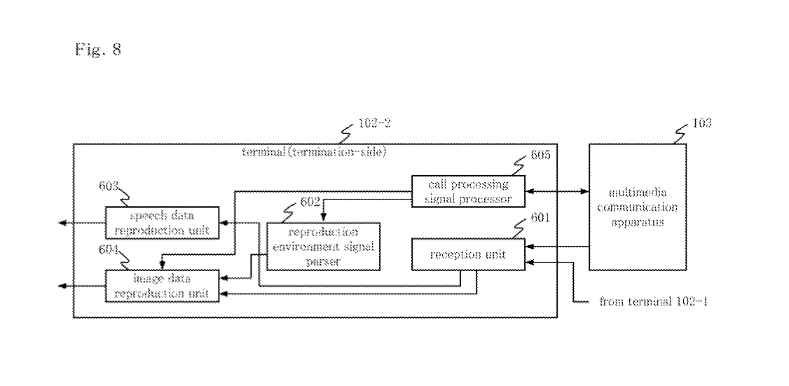

FIG. 8 shows one form of terminal 102-2 shown in FIG. 1. Of the form of terminal 102-2 that is shown in FIG. 1, only the portions of reception functions relating to the present invention are shown in FIG. 8.

As shown in FIG. 8, terminal 102-2 shown in FIG. 1 is provided with reception unit 601, reproduction environment signal parser 602, speech data reproduction unit 603, image data reproduction unit 604, and call processing signal processor 605.

After using, for example, an INVITE command to transmit a speech origination session establishment request to multimedia communication apparatus 103, call processing signal processor 605 waits for the reception of a termination response signal regarding the speech session. When a reINVITE request requesting the establishment of a session other than speech such as an image session is received from multimedia communication apparatus 103 before receiving a termination response signal, call processing signal processor 605 both causes image data reproduction unit 604 to prepare for image data reproduction and causes reproduction environment signal parser 602 to supply and set to image data reproduction unit 604 setting values of various image encoding parameters that were obtained by parsing the reproduction environment signal of the encoded content data that were received together with the reINVITE from multimedia communication apparatus 103.

Reception unit 601 receives encoded content data RTP packets from multimedia communication apparatus 103, extracts the encoded content data from the RTP packets, and supplies the encoded content data to image data reproduction unit 604.

During the interval until a halt signal arrives from call processing signal processor 605, image data reproduction unit 604 decodes and reproduces the encoded content data that were received from reception unit 601 by means of the image encoding parameters that were set. When a halt signal arrives from call processing signal processor 605, image data reproduction unit 604 immediately halts the decoding and reproduction of the encoded content data.

Upon receiving the termination response signal of terminal 102-2 from multimedia communication apparatus 103, call processing signal processor 605 supplies an instruction to image data reproduction unit 604 to halt the decoding and reproduction of encoded content data. Call processing signal processor 605 further supplies an instruction to speech data reproduction unit 603 to begin the decoding and reproduction of encoded speech data.

Reception unit 601 receives RTP packets that store encoded speech data from partner terminal 102-1, extracts the encoded speech data and supplies the data to speech data reproduction unit 603.

Upon receiving an instruction to begin decoding and reproduction of the encoded speech data from call processing signal processor 605, speech data reproduction unit 603 receives the encoded speech data as input from reception unit 601 and carries out decoding and reproduction to supply a speech signal. If reproduction environment information has been supplied from call processing signal processor 605 at this time, the speech data are reproduced based on the reproduction environment information.

At this time, the content that is read may be content that has been selected in accordance with the termination-side terminal as in the first exemplary embodiment. Alternatively, content may also be selected and read in accordance with the origination-side terminal.

In the present exemplary embodiment as described hereinabove, when speech conversation is to be implemented from terminal 102-1 to terminal 102-2, predetermined content is reproduced in terminal 102-2 under conditions that are appropriate to terminal 102-2 and to the content while terminal 102-1 is calling terminal 102-2.

In addition, although call control unit 205 is installed in multimedia communication apparatus 103 in FIG. 6 in the present exemplary embodiment as described hereinabove, call control unit 205 alone can be implemented in a device other than multimedia communication apparatus 103. Adopting such a configuration is advantageous because scalability can be flexibly ensured. In addition, the notification of instructions can be realized by using SIP or MEGACO between call processing signal processor 1001 and the device of call control unit 205.

### Third Exemplary Embodiment

Multimedia communication apparatus 103 can also be considered that is provided with both the functions belonging to the first exemplary embodiment described above and the functions belonging to the second exemplary embodiment.

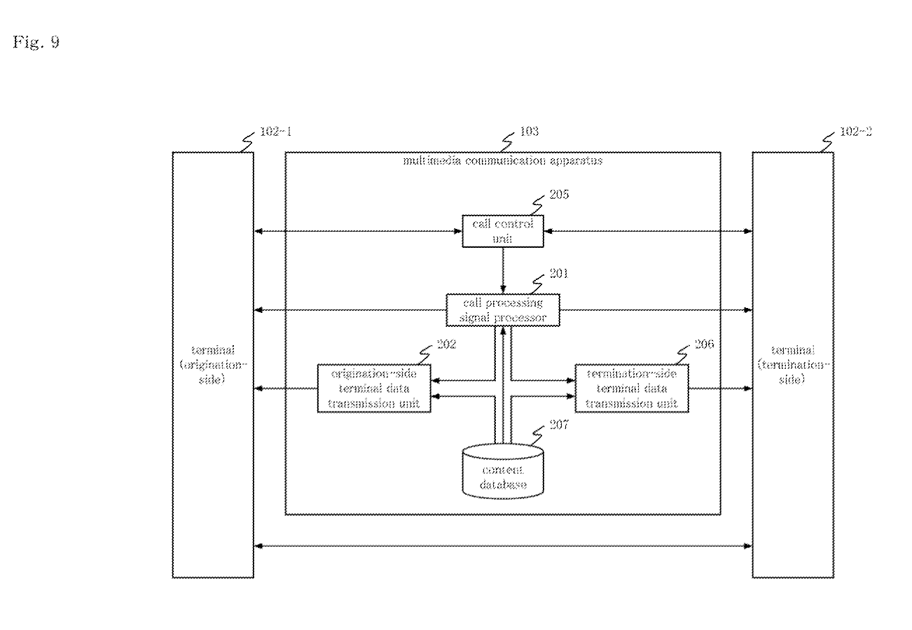

FIG. 9 shows the third exemplary embodiment of multimedia communication apparatus 103 shown in FIG. 1.

As shown in FIG. 9, the third exemplary embodiment of multimedia communication apparatus 103 shown in FIG. 1 is of a form that is equipped with both the functions belonging to the first exemplary embodiment shown in FIG. 2 and the functions belonging to the second exemplary embodiment shown in FIG. 6.

### Fourth Exemplary Embodiment

Multimedia communication apparatus 103 described hereinabove can also distribute advertisement content to terminals 102-1-102-n as a media server.

FIG. 10 shows the fourth exemplary embodiment of multimedia communication apparatus 103 shown in FIG. 1.

As shown in FIG. 10, in the present exemplary embodiment, a plurality of terminals 102-1-102-n are connected by way of network 101 to media server 3201 that is a multimedia communication apparatus. In addition, advertisement content database 3202 is connected to media server 3201.

Advertisement content database 3202 stores advertisement content that is to be distributed to terminals 102-1-102-n by way of network 101. This advertisement content may be images or may be characters.

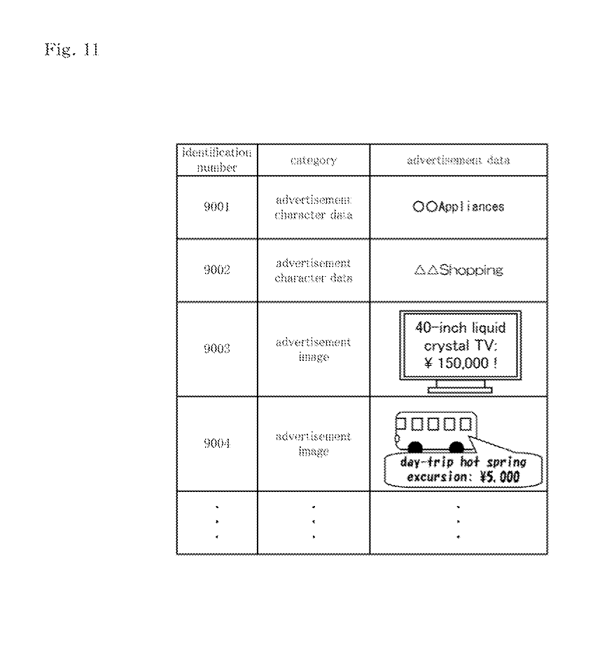

FIG. 11 shows one construction of advertisement content database 3202 that is shown in FIG. 10.

As shown in FIG. 11, advertisement character data or advertisement images are stored as advertisement data in advertisement content database 3202 shown in FIG. 10. An identification number that is uniquely conferred to each data item and a category are stored in correspondence with each item of advertisement data. For example, the identification number “9001” and the category “advertisement character data” are placed in correspondence with the characters of the advertisement data “00 Appliances.” In addition, the identification number “9002” and the category “advertisement character data” are placed in correspondence with the character advertisement data “ΔΔ Shopping.” Still further, the identification number “9003” and the category “advertisement image” are placed in correspondence with the advertisement data that is an image of a television. Finally, the identification number “9004” and the category “advertisement image” are placed in correspondence with advertisement data of a day-trip hot spring excursion. Advertisement data for which the category is “advertisement image” may be a still picture or a moving picture.

Media server 3201 intermediates in the transfer of speech data or image data that are transmitted and received among terminals 102-1-102-n by way of network 101. Media server 3201 further reads advertisement content from advertisement content database 3202 and distributes the advertisement content to terminals 102-1-102-n by way of network 101. When distributing advertisement content, media server 3201 may distribute advertisement content that has been read from advertisement content database 3202 to terminals 102-1-102-n without alteration.

The timing of distributing advertisement data may be during calling of a termination-side terminal by an origination-side terminal.

The configuration of media server 3201 is identical to the configuration of the above-described multimedia communication apparatus 103.

### Fifth Exemplary Embodiment

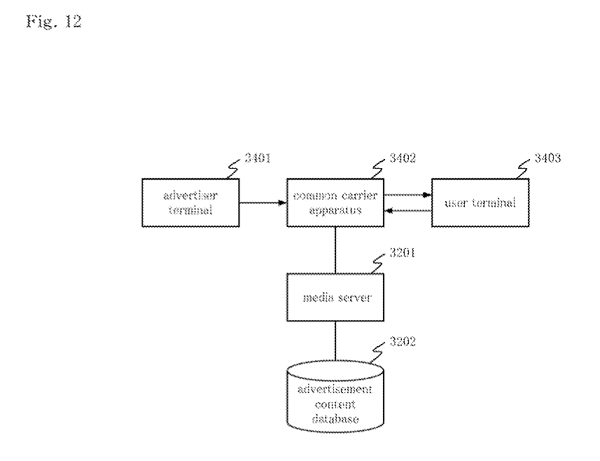

FIG. 12 shows the fifth exemplary embodiment of multimedia communication apparatus 103 shown in FIG. 1.

As shown in FIG. 12, the present exemplary embodiment is of a configuration that allows media server 3201 that is multimedia communication apparatus 103 to connect to common carrier apparatus 3402 that belongs to a common carrier to which a user, that has user terminal 3403, has made contract. In addition, advertisement content database 3202 is connected to media server 3201. Common carrier apparatus 3402 is further able to communicate with advertiser terminal 3401 that belongs to an advertiser.

Advertisement data of advertiser terminal 3401 is registered (stored) in advance in advertisement content database 3202 by advertiser terminal 3401. Through the management by common carrier apparatus 3402 of the advertisement data that are registered in this advertisement content database 3202, advertiser terminal 3401 pays advertising fees to common carrier apparatus 3402.

When carrying out communication, user terminal 3403 carries out the communication by way of common carrier apparatus 3402 and media server 3201. In this case, common carrier apparatus 3402 uses media server 3201 to read advertisement content from advertisement content database 3202 and offers multimedia service to user terminal 3403 as advertisement content of at least one of speech, an image, or a character string that is transmitted from media server 3201 to the termination-side terminal or origination-side terminal that belongs to user terminal 3403.

It is then recorded in common carrier apparatus 3402 or media server 3201 that advertisement data have been transmitted to user terminal 3403, and based on this record (transmission frequency), preferential treatment such as a reduction of call charges or the dispensation of call charges can then be given to user terminal 3403 to which the advertisement data have been transmitted. Preferential treatment information for implementing this preferential treatment is stored in a preferential treatment information database (not shown) that is equipped in common carrier apparatus 3402 or media server 3201, and may be read to adjust charges when assessing call charges to user terminal 3403.

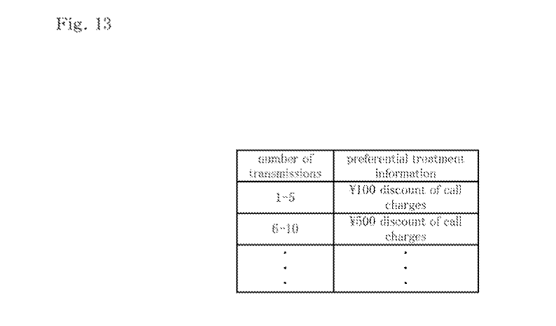

FIG. 13 shows one configuration of the preferential treatment information database in which the number of transmissions of advertisement data and preferential treatment information are placed in correspondence.

As shown in FIG. 13, the number of transmissions of advertisement data and the preferential treatment information in such cases are stored in association with each other. For example, the preferential treatment information is stored in which a 100-yen discount of call charges is to be given to user terminal 3403 to which advertisement data have been transmitted 1-5 times. Preferential treatment information is further stored in which a 500-yen discount of call charges is to be given to user terminal 3403 to which advertisement data have been transmitted 6-10 times.

Preferential treatment may also be realized according to the transmission time of advertisement data.

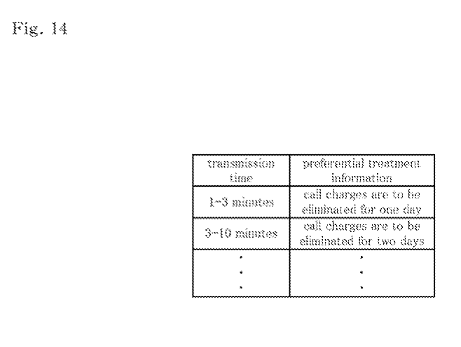

FIG. 14 shows one configuration of a preferential treatment database in which the transmission time of advertisement data is placed in correspondence with the preferential treatment information.

As shown in FIG. 14, the transmission time of advertisement data and the preferential treatment information in this case are stored in association with each other. For example, the preferential treatment information in which call charges are to be eliminated for one day is stored for user terminal 3403 for which the advertisement data transmission time is 1-3 minutes. In addition, the preferential treatment information in which call charges are to be eliminated for two days is stored for user terminal 3403 for which the advertisement data transmission time is 3-10 minutes.

In this way, users receive the multimedia service offered from the common carrier, and by viewing advertisement content, receive benefits such as the reduction or elimination of call charges according to the transmission frequency.

This preferential treatment for call charges can also be applied in the above-described first to fourth exemplary embodiments.

In the above-described exemplary embodiments, content or character strings can be selected from terminals 102-1-102-n. For example, applying the identification numbers of content or character strings as input to terminals 102-1-102-n enables the selection of desired content or character strings. Alternatively, the above-described identification numbers may be placed in association with each of terminals 102-1-102-n, and the content or character strings that have been placed in correspondence with terminals 102-1-102-n that originate or terminate a call may then be read and displayed. Content or character strings that are stored in content database 207 are stored in advance.

The first to third exemplary embodiments described hereinabove may be combined in any combination as necessary.

Although the invention of the present application has been described with reference to exemplary embodiments, the invention of the present application is not limited to the above-described exemplary embodiments. The constitution and details of the invention of the present application are open to various modifications within the scope of the invention of the present application that will be clear to one of ordinary skill in the art.

This application claims the benefits of priority based on Japanese Patent Application No. 2008-322644 for which application was submitted on Dec. 18, 2008 and incorporates by citation all of the disclosures of that application.

1. A multimedia service providing method in a multimedia communication system that is made up of a plurality of terminals and a server that is connected to the plurality of terminals, that processes call processing signals of the plurality of terminals, and that has a database in which are stored content data that include images and reproduction environment information that indicates the reproduction environment of the content data; the multimedia service providing method comprising steps of:
said server reading said content data and said reproduction environment information from said database in the interval from placing a call by, from among said plurality of terminals, an origination-side terminal that performs speech call origination to, from among said plurality of terminals, a termination-side terminal that is the communication partner of said origination-side terminal, until the time that said termination-side terminal responds;
in the interval until said termination-side terminal responds, said server issuing a request to said origination-side terminal or said termination-side terminal to additionally establish a session composed of something other than speech and transmitting said reproduction environment information and said content data that were read to said origination-side terminal or said termination-side terminal that is issued said request; and
in the interval until said termination-side terminal responds, said origination-side terminal or said termination-side terminal reproducing content data that were transmitted from said server based on said reproduction environment information.

2. The multimedia service providing method as set forth in claim 1, further comprising steps of:
said server using SIP to process said call processing signals and session control signals that control said session; and
said server using SDP to process said reproduction environment information.

3. (canceled)

4. (canceled)

5. The multimedia service providing method as set forth in claim 1, wherein said content data include character information.

6. The multimedia service providing method as set forth in claim 1, wherein said content data include images that include advertisement images.

7. The multimedia service providing method as set forth in claim 1, wherein an end user registers at least a portion of said content data.

8. The multimedia service providing method as set forth in claim 5, wherein said character information is registered in advance by an end user.

9. The multimedia service providing method as set forth in claim 1, further comprising steps of:
using a file format of 3GP or MP4 format to store said content data in a file and then storing it in said database; and
in the interval until said termination-side terminal responds, using HTTP or TCP to transmit said file that was stored in said database to said origination-side terminal or said termination-side terminal that is issued said request.

10. (canceled)

11. A server that is connected to a plurality of terminals and that processes call processing signals of said plurality of terminals, comprising:
a database in which are stored content data that include images and reproduction environment information that indicates the reproduction environment of the content data;
a call processing signal processor that, in the interval from placing a call by, from among said plurality of terminals, an origination-side terminal that performs speech call origination to, from among said plurality of terminals, a termination-side terminal that is the communication partner of said origination-side terminal, until the time that said termination-side terminal responds, reads said reproduction environment information from said database, transmits said reproduction environment information that was read to said origination-side terminal or said termination-side terminal, and issues a request to said origination-side terminal or said termination-side terminal which said reproduction environment information is transmitted to, to additionally establish a session composed of something other than speech; and
terminal data transmission unit that, in the interval until said termination-side terminal responds, reads said content data from said database and transmits said content data that were read to said origination-side terminal or said termination-side terminal which said reproduction environment information is transmitted to.

12. (canceled)

13. A multimedia communication system that is made up of a plurality of terminals and a server that is connected to the plurality of terminals and that processes call processing signals of the plurality of terminals, wherein:
said server has a database in which are stored content data that include images and reproduction environment information that indicates the reproduction environment of the content data, and that further, in the interval from placing a call by, from among said plurality of terminals, an origination-side terminal that performs speech call origination to, from among said plurality of terminals, a termination-side terminal that is the communication partner of said origination-side terminal, until the time that said termination-side terminal responds, reads said content data and said reproduction environment information from said database, issues a request to said origination-side terminal or said termination-side terminal to additionally establish a session composed of something other than speech, and transmits said content data and said reproduction environment information that were read to said origination-side terminal or said termination-side terminal that is issued said request; and
said origination-side terminal or said termination-side terminal, in the interval until said termination-side terminal responds, reproduces content data that were transmitted from said server based on said reproduction environment information.

14. (canceled)
